(19) United States
(12) Patent Application Publication
(10) Pub. No.: US 2025/0350681 A1
(43) Pub. Date: Nov. 13, 2025

(54) METHODS AND SYSTEMS FOR COMMUNICATION MANAGEMENT

(71) Applicant: Comcast Cable Communications, LLC, Philadelphia, PA (US)

(72) Inventors: Eric Wong, Mount Laurel, NJ (US); Vengatarajulu Rajasekar, Mount Laurel, NJ (US); Alex Model, Mount Laurel, NJ (US)

(21) Appl. No.: 18/660,983

(22) Filed: May 10, 2024

(51) Int. Cl. H04M 3/42; H04W 4/16

(52) U.S. Cl. CPC H04M 3/42042; H04W 4/16

(57) ABSTRACT

Methods and systems for communication management are described. Supplemental data may be inserted into an outgoing call. It may be determined the recipient device is not configured to process the supplemental data. Audio data may be output.

### BACKGROUND

A rise in spam calls has led to an increase in phone users ignoring calls from unknown numbers. This behavior is driven by a desire to reduce exposure to scams, annoyance, and wasted time. In the case of legitimate calls from unknown numbers there is a lack of capability for callers to provide additional information to the intended recipient, and thereby increase the chances the intended recipient will answer the call from the unknown number. Recipients ignoring legitimate calls solely because the recipient does not recognize the number leads to business losses, service interruptions, and other problems. Rich Call Data (RCD) may allow callers to provide additional information to intended recipients, but not all receiving user devices are configured to process RCD.

### SUMMARY

It is to be understood that both the following general description and the following detailed description are exemplary and explanatory only and are not restrictive. Methods and systems for call management are described. It may be determined that a receiving user device is not configured to process RCD. Audio data may be inserted into a communication and output at a receiving device. The audio data may be configured as a pre-call announcement.

### BRIEF DESCRIPTION OF THE DRAWINGS

The accompanying drawings, which are incorporated in and constitute a part of this specification, show examples and together with the description, serve to explain the principles:

FIGS. 1A-1B show an example system;

FIG. 2 shows an example system;

FIG. 3 shows an example method;

FIG. 4 shows an example method;

FIG. 5 shows an example method;

FIG. 6 shows an example method;

FIG. 7 shows an example method;

FIG. 8 shows an example method;

FIG. 9 shows an example method;

FIG. 10 shows an example method; and

FIG. 11 shows an example system for communication management.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. If such a range is expressed, another configuration includes from the one particular value and/or to the other particular value. Similarly, if values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is to be understood that if combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information.” Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 4k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 3 (.MP3) format, Adobe®, CableLabs 1.0,1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

The present methods and systems provide an improvement in communications technologies and related technologies

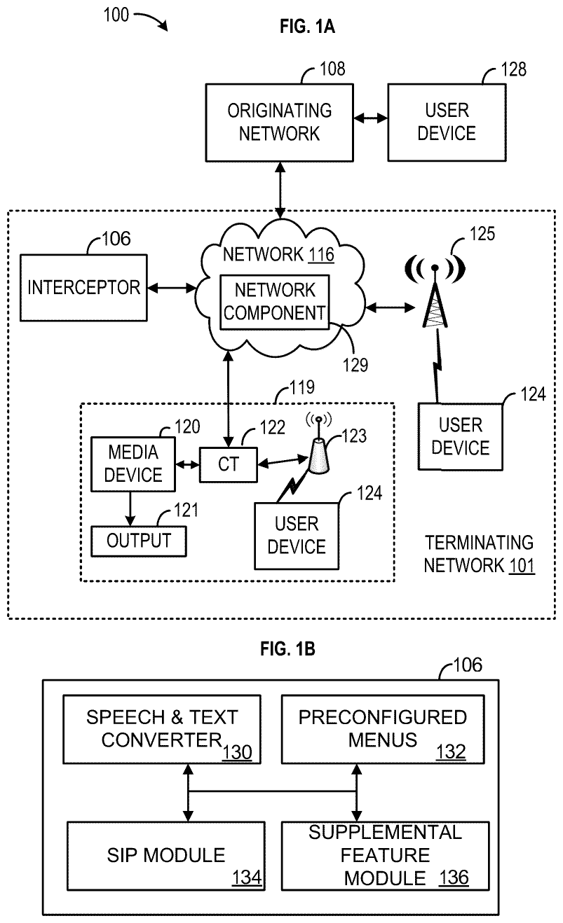

FIG. 1 shows a system 100 for communication management. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a terminating network 101, an originating network 108, and one or more intermediary networks. Although network 116 is shown in the terminating network 101, the illustration is merely exemplary and explanatory and not limiting. For example, the network 116 may be an intermediary network (e.g., a transit network) between the terminating network 101 and the originating network 108. The system 100 may comprise a terminating user device 124 in the terminating network and an originating user device 128 associated with the originating network 108. The terminating network 101 may comprise a media device 120, an output device 121, a communications terminal 122, a first access point 123, a second access point 125 (e.g., a headend, fiber optic, or satellite communications facility), various other devices, combinations thereof, and the like.

The network 116 may facilitate sending data to and from the various devices of the system 100. The network 116 may be a telecommunications network, a content delivery network, a content access network, combinations thereof, and the like. The network may be managed (e.g., deployed, serviced) by a content provider, a service provider, combinations thereof, and the like. The network 116 may be a plain-old telephony (POTS) network, a wireless cellular network, an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like.

The user device 124 may comprise one or more of a cell phone, a smart phone, a laptop computer, a desktop computer, a tablet, a virtual assistant device, a plain old telephone (POTS), combinations thereof and the like. The network device may be the interceptor device 106. The interceptor device may be referred to as an “intermediary device.” The user device 124 may be configured to receive an incoming call and/or to place an outgoing call. The term “incoming call” refers to a point of view of the device and/or network receiving the call (e.g., the terminating device or the terminating network). The term “outgoing call” may refer to the same call, but from the point of view of the device placing the call and/or the network associated with the device placing the call. For example, a call may be placed by the user device 128 (e.g., the originating device) and directed towards the user device 124 (e.g., the terminating device). Thus, from the point of view of the user device 128, the call is an outgoing call, but from the point of view of the user device 124, the call is an incoming call.

For example, the call may be placed automatically in response to a wake word or other similar trigger. The call may be bound for a recipient device (e.g., the user device 124). The recipient device may be associated with the recipient network (e.g., the terminating network 101). The call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

The call may comprise supplemental data. The supplemental data may comprise rich call data (RCD). The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. The rich call data may be inserted, for example, into one or more fields of a session initiation protocol (SIP) invite. For example, the rich call data may comprise the responses to the one or more outputs (e.g., the user inputs received in response to the one or more prompts) so as to convey additional information to the recipient of the call. The rich call data may comprise image data (e.g., a logo), text data (e.g., a message configured to be displayed via the recipient device), audio data, one or more resource identifiers (e.g., one or more URLs, or the like), combinations thereof, and the like.

The supplemental data may comprise caller ID data, call parameter data, session description data, media negotiation data, network address data, call routing data, presence data, service-specific data, and/or error and status data. For example, In a VoIP invite or call initiation message, various supplemental data elements may be included to manage and facilitate the communication session. For example, the caller ID data may comprise essential information about the caller, such as their name, phone number, or username. For example, the call parameters may be conveyed to specify settings like call type (voice, video, conference), priority, supported codecs, and preferred media formats. For example, the session description may be provided, delineating session characteristics such as duration, start and end times, and any associated scheduling details. For example, media negotiation information is exchanged to determine compatible codecs, media formats, and bandwidth constraints between parties. For example, the network addressing information, including IP addresses and ports, may be shared to establish the connection between the calling and called parties. For example, the authentication and security details, encompassing mechanisms, encryption algorithms, and protocols used to secure the session, may be communicated. For example, the call routing information is may be communicated to indicate the path and network elements involved in connecting the parties, including gateways or proxies. For example, the presence information may convey the availability status of the caller, indicating whether they are reachable at the moment. Additionally, service-specific data such as call history, recording preferences, or customized features may be included. Finally, error and status codes may be transmitted to communicate the outcome of the call initiation process, indicating success, failure, or encountered errors.

The interceptor device 106 may detect the incoming call. The interceptor device 106 may comprise a switch. The switch may comprise various components within a cellular network infrastructure, facilitating the routing of calls, data, and other communication signals between different network components. For example, among these components may be the Mobile Switching Center (MSC), responsible for managing call setup, routing, termination, and mobility management between mobile devices and external networks such as the Public Switched Telephone Network (PSTN). The switch may comprise a Base Station Controller (BSC) configured to oversee multiple Base Transceiver Stations (BTS) and manage radio resources and handovers. In modern networks like 4G LTE and 5G, packet switches are essential for handling data traffic, ensuring the smooth transmission of data packets between various network elements. These switches collectively manage voice and data traffic, optimize network resources, and uphold reliable connectivity for users across the cellular network.

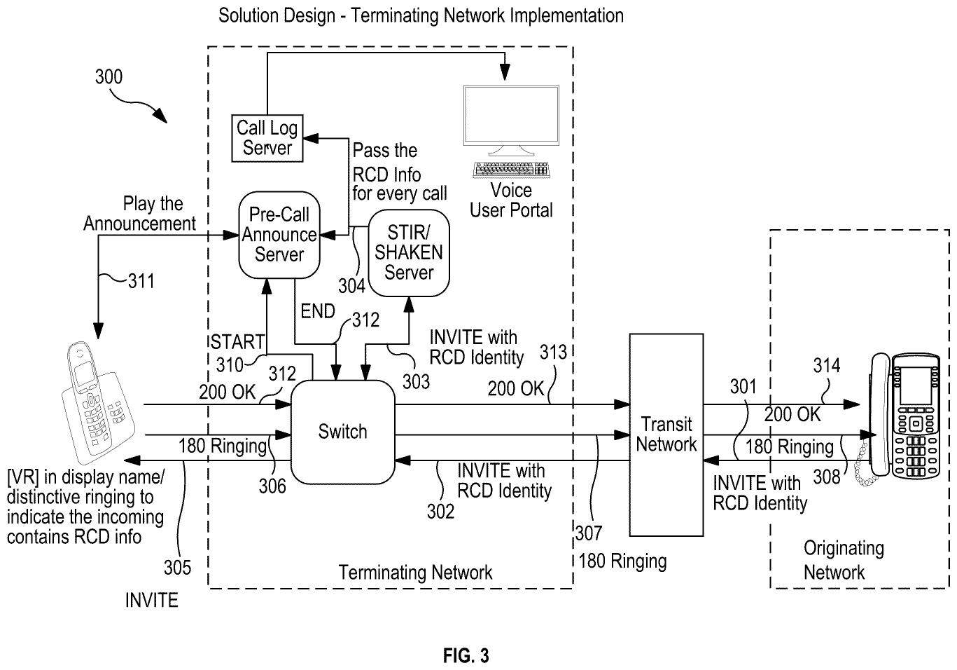

The interceptor device 106 may determine the call comprises supplemental data (e.g., rich call data). The interceptor device may determine a user device identifier associated with the recipient device (e.g., an identifier associated with the user device 124). The interceptor device may determine, for example, based on the user device identifier associated with the recipient device, that the recipient device is not configured to process the supplemental data. Based on determining the recipient device is not configured to process the supplemental data, the interceptor device may take one or more actions. For example, the interceptor device 106 may forward the call to one or more other devices. For example, the interceptor device 106 may forward the call to a STIR/SHAKEN server (not shown). The STIR/SHAKEN server may be configured to implement the Secure Telephone Identity Revisited (STIR) and Signature-based Handling of Asserted Information Using toKENs (SHAKEN) framework, which authenticate and verify caller identities. This process involves digitally signing caller information and transmitting it across the network to ensure its integrity and authenticity. By implementing STIR/SHAKEN protocols, the server helps mitigate the prevalence of fraudulent calls by providing carriers and consumers with accurate caller identification information, thus enhancing trust and security within the telecommunications ecosystem. The interceptor device 106 may forward the call and/or any information associated with the call to a pre-call announcement server (as discussed in greater detail in FIG. 3). The call and/or information associated with the call may be sent to a call log server (as discussed in greater detail in FIG. 3). The interceptor device 106 may decode the STIR/SHAKEN data to determine the supplemental data. The supplemental data may comprise one or more claims (e.g., support callback, name, company). The interceptor device 106 may determine one or more RCD headers, and thereby determine the presence of RCD.

The interceptor device may establish a pre-call session (e.g., an early media session) with the terminating device. The interceptor device may establish the pre-call session with the terminating device based on determining the terminating device is not configured to process the RCD.

For example, the interceptor device, based on determining the recipient device is not configured to process rich call data, may cause the recipient device to output audio. The audio may comprise, for example, a pre-call announcement. The audio may be associated with (e.g., determined based on) the RCD. For example, the RCD may comprise text. The text may be converted to speech, and output as audio. For example, the RCD may indicate the presence of a logo associated with a service provider. The logo may be labeled to indicate the service provider. For example, the RCD may comprise image data labeled “COMCAST.” The interceptor device may convert the COMCAST text to speech and output the speech as audio.

The audio may be prerecorded. In that case, the audio may be fetched from an audio database. For example, the audio database may be configured to store one or more pre-recorded audio messages. The interceptor device may determine a device identifier associated with the originating device. For example, the interceptor device may determine a phone number associated with the originating device. The interceptor device may determine a pre-recorded message of the one or more pre-recorded messages based on the identifier associated with the originating device. For example, the interceptor device may determine, based on the identifier associated with the originating device, that the originating device is associated with a first service provider. The interceptor device may determine a pre-recorded message of the one or more pre-recorded messages associated with the service provider.

The interceptor device may cause the pre-recorded message to be output via the recipient device. For example, the pre-recorded message may be output as a pre-call announcement. For example, before opening a full communication session (e.g., channel) between the terminating device and the originating device, the interceptor device may detect a pre-call action at the recipient device. Based on detecting the pre-call action at the recipient device, the interceptor device may cause the pre-recorded message to be output via the recipient device. The interceptor device may cause one or more outputs may be caused at the recipient device. The one or more outputs may be configured to solicit one or more user inputs from a user of the user device. For example, the one or more outputs may comprise one or more voice outputs.

The one or more outputs may comprise one or more voice prompts (e.g., questions, complete the statements, etc. . . . ). The one or more outputs may comprise one or more fillable forms. The one or more outputs may comprise one or more prompts. For example, the one or more prompts may be configured to solicit one or more user inputs from a user associated with the recipient device. For example, the one or more prompts may be configured to solicit one or more button inputs (e.g., “if you would like to answer the call, please press 1”) and/or one or more voice inputs, (e.g., “if you would like to answer the call, say ‘accept’” or “say ‘decline’ to end the call”).

For example, one or more outputs may be one or more voice prompts configured to solicit one or more responses from a user of the originating device. For example, the system may be configured to establishing an early media with the originator using call interceptor, and a user of the originating device may record an audio message. Then the system may establish an early media session with the terminating device and play the recording as an announcement first and prompt the receiver to take an action. If accepted, then the call can be bridged to full end to end communication. For example, based on determining the recipient device is not configured to process the RCD, an early media session may be established with the originating device. For example, a first output may be first prompt such as, “state your name,” or “state your company.” For example, a second output of the one or more outputs may comprise a second prompt such as, “state your reason for calling.” Based on these prompts, the interceptor device may receive audio data and/or text data via the originating device. For example, the user of the originating device may respond by voice, and these voice inputs may be converted to text. For example, a user of the originating device may user a user interface to enter responses. The responses may be converted to supplemental data. For example, the responses may be converted to rich call data. The question-response process may occur before the call is placed, before the early media session, during the early media session, or after the early media session. The one or more user inputs may optionally be converted to rich call data. The one or more user inputs may be converted to rich call data via speech to text conversion. The rich call data may be encoded into the outgoing call. The rich call data may be inserted into the outgoing call and configured to be output on the recipient device. The rich call data may be inserted into the outgoing call before the outgoing call leaves an originating network before entering the recipient network. Similarly, the rich call data may be inserted at the terminating network. The rich call data may be inserted, for example, into one or more fields of a session initiation protocol (SIP) invite. The rich call data may be output via the recipient device. For example, the rich call data may comprise the responses to the one or more outputs (e.g., the user inputs received in response to the one or more prompts) so as to convey additional information to the recipient of the call.

The interceptor device may convert the text data to audio data via a text-to-speech conversion. The interceptor device may cause the audio to be output at the recipient user device via the early media session. The one or more outputs at the recipient device may comprise speech such as, “Joe is calling from COMCAST.” The one or more outputs may comprise one or more voice prompts (e.g., questions, complete the statements, etc. . . . ). The one or more outputs may comprise one or more fillable forms. The one or more outputs may comprise one or more prompts. For example, the one or more outputs may be one or more voice prompts configured to solicit one or more responses from the user of the user device. For example, a first output may be first prompt such as, “would you like to answer?” For example, a second output of the one or more outputs may comprise a second prompt such as, “Press 1 to accept this call” The one or more outputs may be associated with one or more pre-configured menus.

The interceptor device 106 may determine one or more call types associated with the outgoing call. The one or more call types may comprise, for example, a legitimate call type and/or a spam call type. For example, the intercept device may determine the one or more call types based on one or more identifiers associated with the device placing the outgoing call, one or more identifiers associated with a user of the device placing the outgoing call, one or more numbers (e.g., phone numbers) associated with the device placing the outgoing call, one or more identifiers associated with the device receiving the outgoing call, one or more identifiers associated with a user of the device receiving the outgoing call, one or more numbers (e.g., phone numbers) associated with the device receiving the outgoing call, combinations thereof, or the like. For example, the interceptor device 106 may determine the outgoing call is from a user device associated with a number on an authorized list and may intercept the call to facilitate the collection of data to insert into the call as Rich Call Data. For example, the intercept device 106 may determine the outgoing call is a spam call type based on the one or more identifiers. Based on determining the outgoing call is a spam call, the interceptor device 106 may not intercept the spam call. Based on determining the outgoing call is a spam call, the interceptor device 106 may insert one or more preconfigure rich call data into the spam call (e.g., a notification the call may be spam).

One or more recipient user inputs may be received. The one or more recipient user inputs may be received based on the one or more outputs output at the recipient user device configured to solicit the one or more inputs from the user of the user device. The one or more user inputs comprise one or more voice inputs (e.g., voice responses). The one or more user inputs may comprise one or more text inputs. The one or more user inputs may comprise one or more image inputs (e.g., one or more images captured via an image capture device such as a camera of a smartphone).

Based on the one or more user inputs, a full communication session may be established or not established. For example, based on a receipt of a user input indicating the user at the receiving device would like to accept the call, the full communication session may be established.

Returning to the components of system 100, the media device 120 may be configured to receive content and other associated data (e.g., metadata). The media device 120 may comprise a user device such as an STB, computer, mobile phone, combinations thereof, and the like. The media device 120 may be a digital streaming device, a gaming device, a media storage device, a digital recording device, a computing device, a mobile computing device (e.g., a laptop, a smartphone, a tablet, etc.), combinations thereof, and the like.

The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via a communication terminal 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the communication terminal 122, a computer, a TV, a monitor, or a satellite dish. The communication terminal 122 may be located at the user location 119. The communication terminal 122 may be configured to communicate with the network 116. The communication terminal 122 may be a modem (e.g., cable modem), a router, a gateway, a switch, a network terminal (e.g., optical network unit), combinations thereof, and the like. The communication terminal 122 may be configured for communication with the network 116 via a variety of protocols, such as IP, transmission control protocol, file transfer protocol, session initiation protocol, voice over IP (e.g., VOIP), combinations thereof, and the like. The communication terminal 122, for a cable network, may be configured to facilitate network access via a variety of communication protocols and standards, such as Data Over Cable Service Interface Specification (DOCSIS).

A first access point 123 (e.g., a wireless access point) may be located at the user location 119. The first access point 123 may be configured to provide one or more wireless networks in at least a portion of the user location 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the communication terminal 122, the media device 120, and the display device 121 may be implemented as a single device.

The user location 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

FIG. 1B shows an example diagram of one or more components of the interceptor device 106. The interceptor device 106 may comprise a speech and text converter 130. The speech and text converter 130 may be configured to convert speech to text and/or text to speech. For example, the speech to text converter may receive one or more user inputs. The one or more user inputs may be one or more audio inputs (e.g., voice inputs), one or more text inputs (e.g., typed responses), RCD such as image data, tags, metadata, or the like, or one or more image inputs (e.g., one or more images captured by the user device based on the one or more prompts), combinations thereof, and the like. The one or more user inputs may be received (e.g., recorded) in response to the one or more outputs. The one or more outputs may be sent to the user device. The one or more prompts may be configured to solicit one or more user inputs from a user of the user device. For example, the one or more outputs may be one or more voice prompts configured to inform a user of the recipient device and or solicit one or more responses from the user of the user device. For example, a first output may be informative such as “John from Comcast is calling.” For example, a second output may be first prompt such as, “if you wish to accept, say ‘accept.’” The one or more outputs may be associated with one or more pre-configured menus.

The interceptor device 106 may store one or more preconfigured menus 132. The one or more preconfigured menus may be associated with one or more user profiles. For example, the interceptor device 106 may determine the outgoing call is associated with a user profile. For example, the interceptor device 106 may determine the outgoing call is associated with a user profile based on one or more identifiers associated with the outgoing call (e.g., a phone number, user ID, device ID, combinations thereof, and the like). The interceptor module may be configured to determine the outgoing call is associated with a user profile based on one or more response (e.g., the one or more user inputs). For example, a user may indicate the user is calling on behalf of a particular company. The speech to text converter may convert the response to text (e.g., to determine the company name). The preconfigured menus module may determine, based on the company name, one or more preconfigured menus.

The interceptor device 106 may comprise an SIP module 134. The SIP module may be configured to add, remove, edit, store, or otherwise process data to be included or excluded from an SIP invite according to RFC protocols. For example, the SIP module 134 may be configured to populate one or more SIP invite data fields with the text generated based on the user responses to the one or more prompts. A standard SIP (Session Initiation Protocol) handshake may comprise a series of messages exchanged between the initiating device (e.g., the originating device) and the target device (e.g., the recipient device). This exchange is orchestrated to establish, modify, or terminate a communication session. Initially, the originating device may be configured to send an INVITE request to the recipient device, expressing its intent to commence a session. This request contains pertinent information, such as the SIP address of the intended recipient and the type of session desired, whether it may be a voice call, video call, or another form of communication. Upon receipt of the INVITE request, a server may process it and respond with a provisional response (1xx), signifying acknowledgment and indicating that it is actively processing the request. This provisional response may include additional information or headers. Subsequently, the server may further respond with a final response (2xx) once the session has been successfully established. This response may comprise essential details such as the session description (SDP-Session Description Protocol), which may include specifics about the media types, codecs, and network addresses to be employed for the communication session. After the successful establishment of the session, the client may send an ACK (acknowledgment) message to the server, confirming the session setup. Additionally, throughout the duration of the session, either party may need to modify certain parameters, such as adding participants or altering media characteristics. To facilitate this, the party initiating the modification may be configured to send a new INVITE request with the updated parameters, and the other party may respond accordingly. Finally, when the session needs to be terminated, either party may send a BYE request, indicating the desire to end the session. Upon receipt of the BYE request, the recipient sends a final response, and the session may be terminated. Throughout this process, both the client and the server may exchange various SIP messages such as OPTIONS, REGISTER, and NOTIFY, which help manage and facilitate the communication session according to SIP protocol standards.

The interceptor device 106 may comprise a supplemental feature module 136. The supplemental feature module 136 may be configured to determine, generate, receive, send, or otherwise process or provide one or more supplemental features. The one or more supplemental features may comprise, for example, one or more images (e.g., one or more logos, one or more pictures, etc), one or more hyperlinks, one or more applications or applets, one or more gifs, one or more advertisements, one or more emojis, one or more short videos, combinations thereof and the like. The supplemental feature module 136 may be configured to activate or output, on the recipient device, the one or more supplemental features. For example, based on the text generated from the user inputs and/or RCD, the supplemental feature module may determine a logo associated with the company in the response, and cause output of the logo of the company at the recipient device or if the recipient device is not configured to process the logo, may convert text to speech and output the audio associated with the speech.

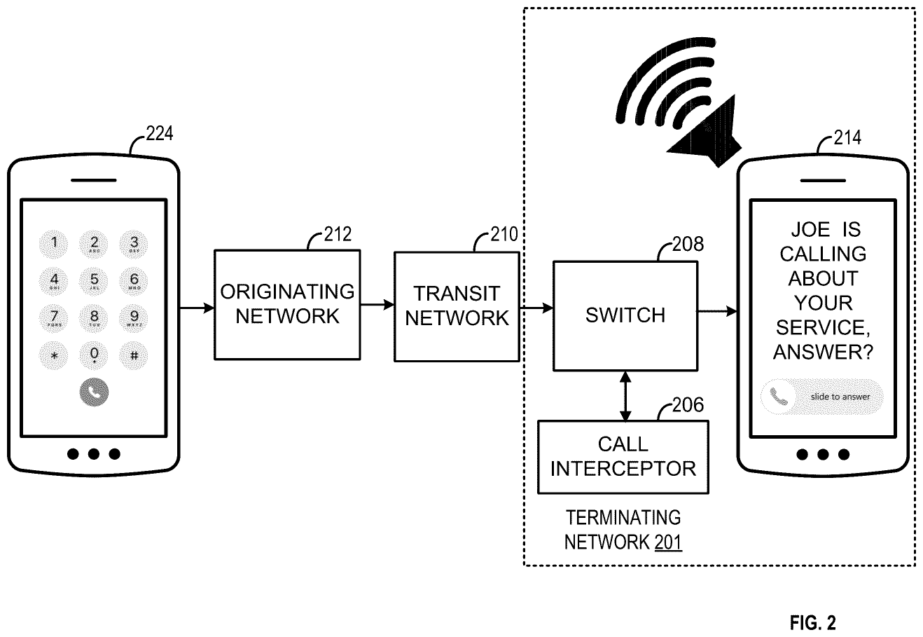

FIG. 2 shows an example system 200. The system 200 may comprise an terminating network 201, an originating user device 224 (e.g., the mobile device 128), a switch 208, a call interceptor 206, a transit network 210, an originating network 212, and a recipient device 214. The user device 214, the switch 208, and the call interceptor 206 may in the terminating network 201. A call may be placed by user device 224. The call may be intended for user device 214. The call may traverse the originating network 212, (optionally) a transit network 210, an be received in the terminating network by switch 208.

The outgoing call may be detected by the switch 208. The switch 208 a switch may be a device within a telephone exchange, such as the public switched telephone network (PSTN), configured to connect calls from the requester to the destination. The switch 208 may be configured to detect a placed call, detect an “off-hook” condition associated with either or both of the user device 224 and/or the user device 214, detect and/or initiate a pre-call session (e.g., an early media session), similar conditions and/or one or more signals related thereto. The outgoing call may comprise one or more of: a session initiation protocol (SIP) invite, a plain old telephony service (POTS) call, voice over internet protocol (VOIP) call, video call, cellular call, voice over LTE call, Wi-Fi call, application message, push-to-talk (PTT) call, or emergency network call.

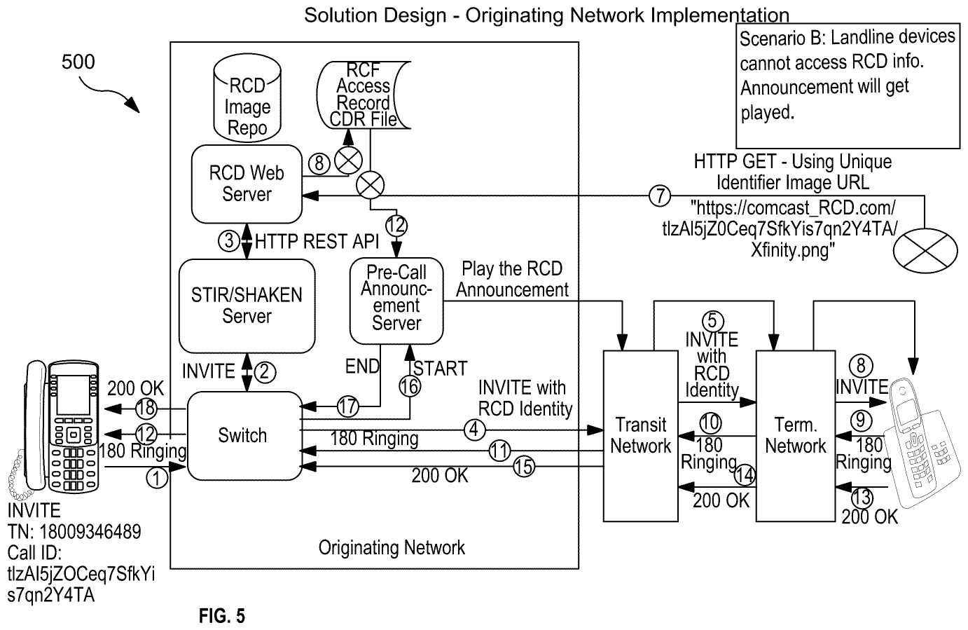

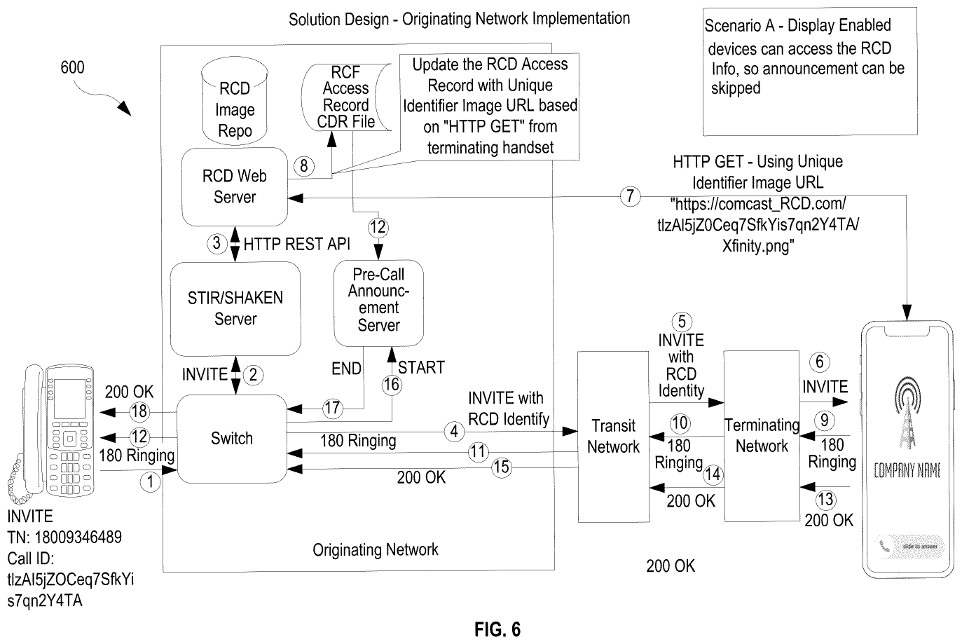

The switch may route the call to the interceptor. The interceptor may route the call to one or more other devices (e.g., as discussed in greater detail in FIG. 3, FIG. 5, and FIG. 6). For example, the interceptor may route the call to a STIR/SHAKEN server (not shown), a call-log server (not shown), a pre-call announcement server (not shown), or any other device. A communication session may be established between the intercept device and either or both of the user device 224 and/or the user device 214. The communication session between the intercept device and the user device(s) may be established based on the intermediary device detecting the call.

The interceptor device 206 may cause one or more outputs to be output at the receiving device 224. For example, audio may be output at the recipient device in a pre-call announcement. The audio may be determined based on RCD in the call. The audio may be determined based on text data. The audio may be based on one or more voice inputs received via the originating device. For example, one or more outputs may be output at the originating device 224. The one or more outputs may be configured to solicit one or more user inputs from a user of the user device 224. The one or more outputs may be caused to be output via the communication session between the intermediary device 206 and the user device 224. The one or more outputs may comprise one or more voice prompts (e.g., questions, complete the statements, etc.). The one or more outputs may comprise one or more prompts (e.g., one or more voice prompts). The one or more outputs may comprise one or more fillable forms. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.” The one or more outputs may be associated with one or more pre-configured menus.

Based on outputting the one or more outputs, one or more inputs may be received via a user interface of the user device 224. The user interface may comprise an audio interface (e.g., a microphone and related technologies). The user interface may comprise a touchscreen or other similar technologies. The one or more user inputs comprise one or more voice inputs (e.g., voice responses). The one or more user inputs may comprise one or more text inputs. The one or more user inputs may comprise one or more image inputs (e.g., one or more images captured via an image capture device such as a camera of a smartphone). The one or more user inputs may comprise responses to the one or more outputs. For example, after outputting the first prompt, “state your name,” a microphone on the user device 224 may be activated (e.g., for a period of time) to record a response. For example, a user may respond “Joe.” A second prompt may solicit more information from the user of the user device. For example, a second prompt may be, “what company do you work for?” A second user input may be a response such as “Comcast.” A third prompt may be “state the reason for your call.” A third user input in response to the third output may be, “I'm calling about the cable box.” The one or more user inputs (e.g., responses) may be formulaic (e.g., they may have the same format) or they may be freeform.

FIG. 3 shows a flowchart of an example method 300. At step 301, a communication request may be placed. The communication request may comprise a call invite. The communication request may comprise supplemental data. For example, the communication request may comprise rich call data, image data, audio data, resource data, combinations thereof, and the like. The communication request may comprise one or more identifiers associated with the originating device (e.g., the device in the originating network) and one or more identifiers associated with the device in the terminating network. At step 302, the communication request may transit the transit network and be received by a switch. At step 303, the switch may forward the call comprising RCD to a STIR/SHAKEN server. The STIR/SHAKEN server may decode the call and determine the RCD. At 304, the STIR/SHAKEN server may send the call and/or any associated information to one or more of a pre-call announcement server and/or a call log server. The call log server may log information associated with the call. The STIR/SHAKEN server and/or the pre-call announcement server may determine the presence of RCD. The STIR/SHAKEN server and/or the pre-call announcement server may determine the content of the RCD. The pre-call announcement server may be configured to convert the RCD text to audio. For example, a header may indicate a caller Joe from a company COMCAST and the audio output may be “Joe from Comcast is calling, would you like to answer?” At step 305, the communication request may be sent to the recipient device.

Optionally, text data may be output on the recipient device to indicate the presence of RCD (even if the device is not configured to output the RCD itself). For example, based on the one or more identifiers associated with the receiving device, it may be determined whether a user associated with the receiving device has opted-in to one or more services (e.g., call authentication/verification based on RCD). For example, if it is determined the customer has opted-in, one or more indications may be output based on the RCD. For example, a [VR] (for verified and RCD present or only [V] for verified, but no RCD present.) or some other indication may be output. At step 306, ringing may be initiated and at step 307, the switch may send the ringing via the transit network to the originating user device (at step 308). The ringing may be distinctive to indicate the presence of RCD (e.g., a special tone may be played when RCD is present). At step 309, an OK signal may be sent to the switch. The OK signal may indicate the call has been “answered” but a communication session between the recipient device and the originating device is not yet established. Based on receiving the OK signal, the switch, at step 310, may send a start command to the pre-call announcement server. The Pre-Call Announcement server may be configured to determine if the incoming call contains RCD data and may be configured to determine whether to play announcement or not. The start command may be configured to cause the pre-call announcement server to play the pre-call announcement at step 311. At the end of the pre-call announcement, the pre-call announcement server may send an end indication to the switch (312). The end indication may be configured to indicate that the pre-call announcement is over. If the call is accepted (e.g., if the user of the recipient device accepts the call after hearing the pre-call announcement and selecting an option), at step 313, the switch may send an OK signal to the transit network and ultimately to the originating device (at step 314).

The method may include converting RCD data to audio. For example, tags associated with the RCD and/or any information in the RCD data itself (e.g., text in one or more headers) may be converted to audio and output via the receiving device as the pre-call announcement.

The method may include determining whether the caller (e.g., the user device sending the outgoing call) is associated with a preconfigured menu or other service. For example, the outgoing call may comprise a user device ID and/or customer ID associated with the user device placing the call. The user device ID associated with the user device placing the call may be associated with a profile. The profile may be associated with a preconfigured service or menu stored in the customer profile database. If the user device ID or customer ID are associated with a profile comprising a preconfigured menu or preconfigured rich call data, the customer profile can be retrieved from a database and the preconfigured menu and/or preconfigured rich call data can be used to update the outbound call by, for example, including the rich call data in an SIP invite. The data may be added to the SIP invite via SIP RFC standards (RFC 2543, RFC 3261, STIR/SHAKEN protocols are incorporated herein in their entirety). If, however, the caller is not associated with a pre-configured profile, the call may be ingested into an interactive voice response system (IVR). Further, a user may be prompted for a call reason. For example, one or more outputs may be sent to and received by the originating user device. The one or more outputs may comprise one or more prompts. The one or more prompts may be received based on sending the outgoing call. The one or more prompts may be configured to be output on the originating user device. The one or more prompts may comprise one or more audible prompts (e.g., one or more voice prompts), one or more visual prompts (e.g., text prompts, image prompts). The one or more prompts may be configured to solicit one or more user inputs from a user of the originating user device. For example, the one or more outputs may be one or more voice prompts configured to solicit one or more responses from the user of the user device. For example, a first output may be first prompt such as, “state your name.” For example, a second output of the one or more outputs may comprise a second prompt such as, “state your reason for calling.”

Further, the responses to the one or more prompts may be recorded and/or stored (e.g., in the call log server). For example, the one or more responses to the one or more prompts may be stored for future use and/or may be played back to the user so the user can confirm the one or more responses are accurate. Optionally, the user may be presented with an option to re-record or otherwise resubmits the one or more user inputs. The user of the originating device may confirm the call reason. The one or more recorded user inputs may be converted, via speech to text conversion, to text. The text may be converted to audio, and output at the recipient user device as the pre-call announcement. The method may comprising asking a user of the originating device if they would like to use the recorded use inputs for future calls. If so, the one or more user inputs (e.g., the one or more call reasons) may be stored in a customer profile in a customer profile database.

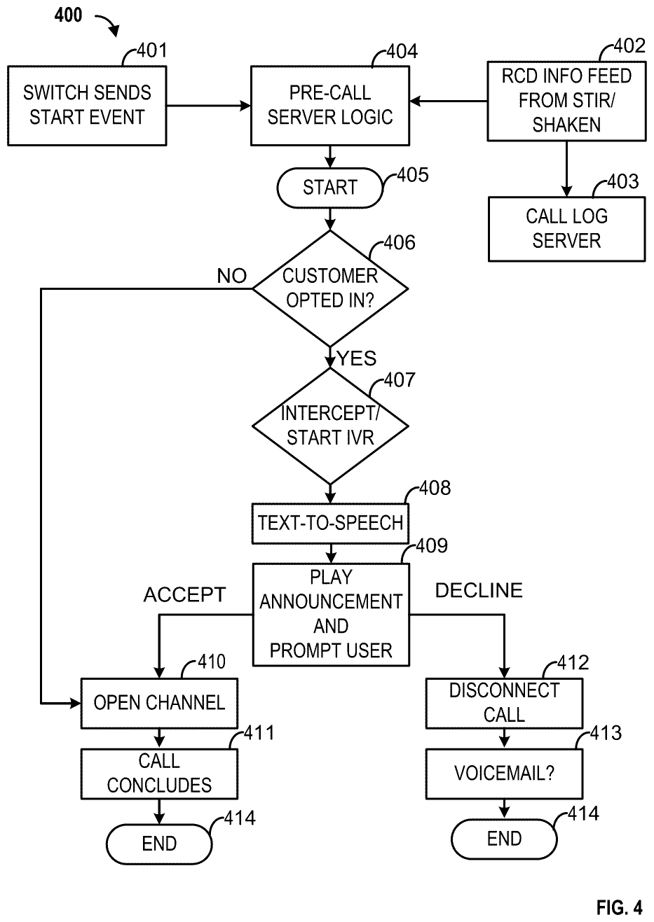

FIG. 4 shows a flowchart of a method 400. The method 400 may be carried out on any one or more of the devices described herein. The method may start at 401 where the switch may send a start event signal to the pre-call server. At 402, RCD info determined by the STIR/SHAKEN server may be received by the pre-call server from the STIR/SHAKEN server. Optionally, at 403, the RCD info from the STIR/SHAKEN server may be sent to the call log server. At 404, pre-call server logic may initiate. At 405, the pre-call server logic may initiate. At 406, it may be determined whether a user associated with the receiving device has opted into pre-call announcement service (e.g., the customer has indicated they would like to hear pre-call announcements prior to determining whether to accept the call and ultimately establishing a full communication session with the originating device). If yes, the method may proceed to 407 where an intercept/interactive voice response process may be initiated. Interactive Voice Response (IVR) may be an automated phone system technology configured to allow callers to access information via a voice response system of pre-recorded messages without having to speak to an agent, as well as to utilize menu options via touch tone keypad selection or speech recognition to have their call routed to specific departments or specialists.

At 408, text may be converted to speech. The text may be included in RCD or may be solicited from a user of the originating device upon determination that the recipient device is not configured to process RCD. The text may be determined based one or more voice inputs received from a user of the originating device. At 409, a pre-call announcement may be played. The pre-call announcement may be generated based on the text-to-speech conversion of step 408. Also at step 409, a user may be prompted and/or presented with one or more options. For example, a first option of the one or more options may be to accept the call, while a second option of the one or more options may be to decline the call. The user of the recipient device may select an option of the one or more options by, for example, selecting a key, entering text, and/or responding vocally. Should the user accept the call, a full communications session between the originating device and the receiving device may be opened at 410. Optionally, the user may decline the call and, at step 412, the call may be disconnected based on the user declining the call. Optionally, at 413, if the call is declined, the call may be routed to voicemail. A traditional voicemail may be record and/or the audio generated as a result of the text to speech conversion may be stored in the voicemail. At step 411, the call may conclude, the communication session may be torn down, and at 414 (shown twice), the process may be ended.

FIG. 5 shows an example method 500 where the receiving device in the terminating network is not configured to process RCD, and the pre-call announcement server and other associated logic is in the originating network. The method 500 may be associated with an originating network implementation. The method 500 may be carried out on any one or more of the devices described herein. For example, at 1, a communication request may be sent from a device in the originating network. The communication request may comprise a call invite. The communication request may comprise one or more identifiers associated with the originating device, one or more identifiers associated with the intended recipient device, one or more invite identifiers, and one or more call identifiers. The communication request may be sent to the switch. At 2, the switch may send the communication request to a STIR/SHAKEN server. The STIR/SHAKEN server may parse STIR/SHAKEN data. The STIR/SHAKEN server may, at 3, send any one or more of the identifiers to an RCD web server which may comprise an RCD image repository. The RCD web server may associate any of the one or more identifiers in the communication request with one or more resource identifiers. At 4, the communication request with RCD identifiers (e.g., resource identifiers) may be sent to a transit network, from the transit network to the terminating network (at 5) and ultimately to the receiving device (at 6). The RCD server, by virtue of not receiving a request from the receiving device, may determine the receiving device is not configured to process RCD data (e.g., including the one or more resource identifiers). Because the receiving device is not configured to process RCD, 7 (the HTTP GET) and 8 (updating the RCD access database) do not happen. 9-12 proceed according to standard SIP protocol. An OK signal is sent at 13 from the receiving device, to the terminating network, and then to the transit network (at 14) and to the switch (15). At 16, the pre-call announcement server causes output of a pre-call announcement at the receiving device. At 17, the pre-call announcement ends, and if the call is accepted by the user of the receiving device (e.g., by virtue of one or more options being selected), an OK signal is sent at 18 to the originating device, and a communication session may be established between the originating device and the receiving device.

FIG. 6 shows an example method 600 where the receiving device in the terminating network is configured to process RCD. The method 600 may be associated with an originating network implementation. The method 600 may be carried out on any one or more of the devices described herein. For example, at 1, a communication request may be sent from a device in the originating network. The communication request may comprise one or more identifiers associated with the originating device, one or more identifiers associated with the intended recipient device, one or more invite identifiers, and one or more call identifiers. The communication request may be sent to the switch. At 2, the switch may send the communication request to a STIR/SHAKEN server. The STIR/SHAKEN server may parse STIR/SHAKEN data. The STIR/SHAKEN server may, at 3, send any one or more of the identifiers to an RCD web server which may comprise an RCD image repository. The RCD web server may associate any of the one or more identifiers in the communication request with one or more resource identifiers. At 4, the communication request with RCD identifiers (e.g., resource identifiers) may be sent to a transit network, from the transit network to the terminating network (at 5) and ultimately to the receiving device (at 6). The receiving device, if configured to, may parse the RCD data, determine the resource identifier, and send a request (at 7) to the RCD web server for a resource associated with the resource identifier. For example, the receiving device may send an HTTP GET based on the identifier. Based on receiving the request comprising the resource identifier from the receiving device, the RCD web server may, at step 8, update an RCD access record (which may be a Call Detail Record file). For example, the RCD access record may be updated with a unique identifier associated with the receiving device to indicate the receiving device received the one or more resource identifiers and processed them. At 8, the RCD web server may update an RCD access record (e.g., CDR file). At 9, the receiving device may send a ringing indication to the terminating network which may send the ringing indication out to a transit network (at 10), to the switch (at 11), and ultimately to the originating device (at 12) so a user associated with the originating device will know the communication request was sent and is currently ringing. If the user of the receiving device has opted into the pre-call announcement service, at 12A the pre-call announcement server may cause the receiving device to output a pre-call announcement and one or more options (e.g., an option to accept the call and/or an option to decline the call). Upon receiving a selection of the option to accept the call, the receiving device may send an OK signal to the terminating network at 13. At 14, the terminating network may send the OK signal to the transit network. At 15, the transit network may send the OK signal to the switch. At 16 the pre-call announcement may be output. At 17, the pre-call announcement may be ended. At 18, an OK signal may be sent to the originating device.

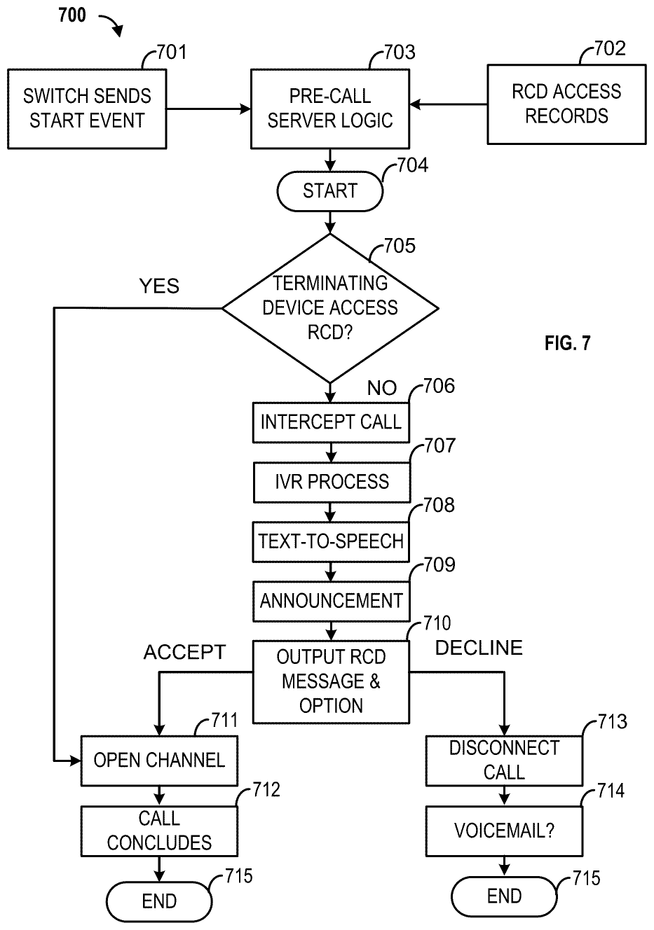

FIG. 7 shows an example method 700. The method 700 may be carried out on any one or more devices described herein. At 701, a switch may send a start event to the pre-call announcement server. At 702, RCD access records may be provided to the pre-call announcement server. At 703, pre-call server logic may be initiated. At 704, a session may be started. At 705, it may be determined whether a terminating device (e.g., the recipient device) access RCD resources. If yes, a session may be opened at 711. If the session is opened and the call commences, upon completion, at 712, the call may conclude and the session may close at 713. If at 705 it is determined that the terminating device did not access RCD, at 706, the communication request may be intercepted. At 707, an interactive voice response protocol may take place. For example, voice data may be gathered. At 708, the voice data, or any other data (e.g., RCD data including images, text, audio, etc. . . . ) may be converted to speech. At 709, a pre-call announcement may be output at the recipient device. The pre-call announcement may comprise the result of the text to speech conversion. For example, the pre-call announcement may comprise one or more indications or caller identity, company identity, reason for call, combinations thereof, and the like. At 710, an RCD message (e.g., the pre-call announcement) may be output. Also at 710, one or more options may be output. For example, a first option of the one or more options may be a call accept option. For example, a second option of the one or more options may be a call decline option. The call accept method was described above. If, at 710, the call is declined, at 713, a communication session (e.g., a preliminary communication session) may be terminated (e.g., disconnected). Optionally, at 714, the originating device may be connected to a voicemail associated with the receiving device. At 715, the process may end.

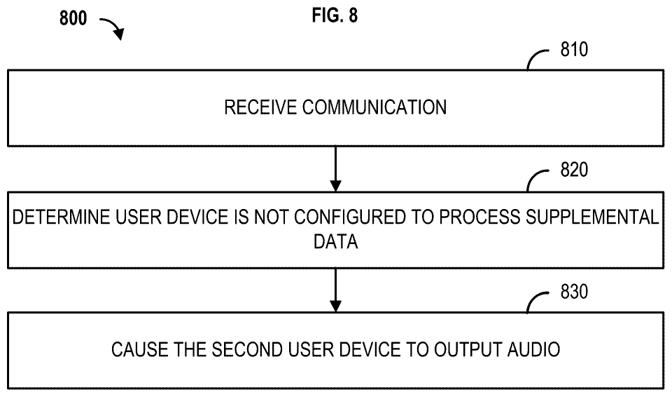

FIG. 8 shows an example method 800. The method 800 may be carried out on any one or more of the devices described herein. At step 810, a communication may be received. The communication may comprise a communication request. The communication may be received by a network device. The network device may comprise a switch device, a server, or other similar device. The communication request may be received by a first user device (e.g., an originating device) and/or any networks associated with the first user device (e.g., an originating network, a transit network, or a terminating network). The communication request may comprise supplemental data (e.g., rich call data (RCD)).

The supplemental data may comprise metadata and/or contextual information associated with a communication session. For example, the supplemental data may comprise image data, video data, audio data, text data, combinations thereof, and the like. The supplemental data may be configured to enrich the user experience and enhance the functionality of telecommunications services. For example, the supplemental data may comprise various elements such as caller identification, call duration, call type (e.g., voice, video, conference), call quality metrics, location information, device capabilities, and user preferences. Additionally, it may include advanced features like presence information, multimedia content sharing, screen sharing, real-time transcription, and integration with third-party applications.

The communication request may comprise one or more identifiers associated with a second user device (e.g., a recipient device). For example, the one or more identifiers associated with the second user device may comprise, for example, one or more IMSIs, one or more IMEIs, one or more MAC addresses, one or more IP addresses, combinations thereof, or the like. For example, the one or more identifiers associated with the second user device may comprise the IMEI (International Mobile Equipment Identity), which is a unique 15-digit code assigned to every GSM and UMTS mobile phone. The one or more user identifiers associated with the second user device may comprise one or more MEID (Mobile Equipment Identifier), which serves a similar purpose to the IMEI but is used for CDMA mobile devices. The second user device may also have an ESN (Electronic Serial Number), a unique identification number embedded in CDMA phones. Another identifier associated with the second user device is the ICCID (Integrated Circuit Card Identifier), a unique serial number linked to the SIM card installed in the device, facilitating cellular communication. The second user device can be identified by its MAC Address (Media Access Control Address), a unique identifier assigned to the device's network interface controller for communication on a network. Bluetooth connectivity on the device is distinguished by a Bluetooth MAC Address, akin to the MAC address but specific to Bluetooth connections. In the digital realm, the second user device may possess an Android ID, a 64-bit number uniquely identifying the device within the scope of a single user account. For Apple devices, the second user device may be identified by its iOS Identifier for Vendor (IDFV), a unique identifier used by apps to recognize a specific device within the iOS ecosystem. Additionally, Apple devices possess an Advertising Identifier (IDFA), an anonymous identifier generated for advertising purposes. Similarly, Google devices have a Google Advertising ID (GAID), serving the same purpose as the IDFA but for devices operating within the Android ecosystem. Another identifier associated with the second user device is its phone number, assigned to the device's SIM card for voice calls and text messaging. Furthermore, the second user device may possess a Serial Number, a unique identifier provided by the manufacturer for device identification and warranty purposes. It also has a Build Number, serving as an identifier associated with the software build installed on the device. The Subscriber Identity Module (SIM) Serial Number is another identifier, unique to the SIM card inserted into the second user device. Finally, while not a static identifier, location data generated by the second user device can also serve as an identifying factor in certain contexts, providing insights into the device's whereabouts and usage patterns. These identifiers may collectively serve various functions, including device authentication, tracking, analytics, and targeted advertising.

At 820, it may be determined that the second user device is not configured to process the supplemental data. For example, it may be determined that the second user device is not configured to process the supplemental data based on the one or more identifiers associated with the second user device. For example, one or more devices at the terminating network may determine, based on the one or more identifiers associated with the second user device, that the second user device is not configured to process the supplemental data.

At 830, the second user device may be caused to output an audio representation of the supplemental data. For example, the audio representation of the supplemental data may be generated based on a text to speech conversion of the supplemental data and/or data associated with the supplemental data. For example, the supplemental data may comprise image data (e.g., a logo), text data (e.g., a message configured to be displayed via the recipient device), audio data, one or more resource identifiers (e.g., one or more URLs, or the like), combinations thereof, and the like. For example, the RCD may indicate the presence of a logo associated with a service provider. The logo may be labeled to indicate the service provider. For example, the supplemental data may comprise image data labeled “COMCAST.” The interceptor device may convert the COMCAST text to speech and output the speech as audio.

The method may comprise converting the supplemental data to text data. The method may comprise converting the text data to audio data. The method may comprise causing the second user device to output the audio representation of the supplemental data by causing the second user device to play a pre-call announcement. The method may comprise determining the second user device is not configured to process the supplemental data based on the one or more identifier associated with the second user device. The method may comprise receiving, from the second user device, a user input. The method may comprise opening, based on the user input, a communication session between the first user device and the second user device. The method may comprise determining, based on a user input associated with the second user device, a communication session open command. The method may comprise opening, based on the communication session open command, a communication session between the first user device and the second user device. The method may comprise sending, to a call log server, text data. The method may comprise sending, to the second user device, a pre-recorded voicemail message. The method may comprise causing, based on the supplemental data, the second user device to modify a notification parameter.

The method may comprise receiving, by a network device, from a first user device, a communication request comprising an identifier associated with a second user device. The method may comprise inserting, by the network device, into the communication request, a resource identifier. The method may comprise sending, based on the identifier associated with the second user device, the communication request. The method may comprise receiving, from the second user device, based on the resource identifier, a resource request. The method may comprise causing, based on the resource request, the second user device to output audio. The method may comprise receiving, from the second user device, based on the audio, a user input. The method may comprise opening, based on the user input, a communication session between the first user device and the second user device.

The method may comprise receiving, by a network device, from a first user device, a communication request comprising an identifier associated with a second user device. The method may comprise inserting, by the network device, into the communication request, a resource identifier. The method may comprise sending, based on the identifier associated with the second user device, the communication request. The method may comprise determining, based on the resource identifier, that the second user device did not send a resource request. The method may comprise based on determining the second user device did not send the resource request, inserting, into the communication request, audio data. The method may comprise causing, based on the audio data, the second user device to output audio.

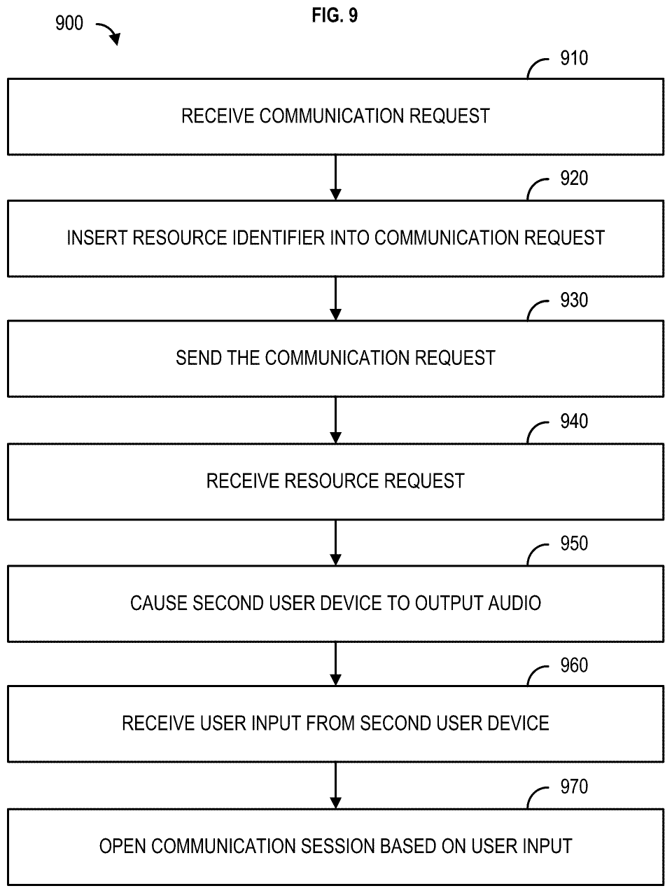

FIG. 9 shows an example method 900. The method 900 may be carried out via any one or more of the devices described herein. At 910, a communication request may be received. The communication request may comprise a call invite. The communication request may be received, for example, by a network device. The network device may comprise a switch, server, or other similar device. The communication request may be received from a first user device (e.g., an originating device) and/or any networks between the network device and the originating device (e.g., an originating network, transit network, or terminating network). The communication request may comprise one or more identifiers associated with a second user device. For example, the communication request may include Call-ID for an SIP invite session. For example, the one or more identifiers associated with the second user device may comprise the IMEI (International Mobile Equipment Identity), which is a unique 15-digit code assigned to every GSM and UMTS mobile phone. The one or more user identifiers associated with the second user device may comprise one or more MEID (Mobile Equipment Identifier), which serves a similar purpose to the IMEI but is used for CDMA mobile devices. The second user device may also have an ESN (Electronic Serial Number), a unique identification number embedded in CDMA phones. Another identifier associated with the second user device is the ICCID (Integrated Circuit Card Identifier), a unique serial number linked to the SIM card installed in the device, facilitating cellular communication. The second user device can be identified by its MAC Address (Media Access Control Address), a unique identifier assigned to the device's network interface controller for communication on a network. Bluetooth connectivity on the device is distinguished by a Bluetooth MAC Address, akin to the MAC address but specific to Bluetooth connections. In the digital realm, the second user device may possess an Android ID, a 64-bit number uniquely identifying the device within the scope of a single user account. For Apple devices, the second user device may be identified by its iOS Identifier for Vendor (IDFV), a unique identifier used by apps to recognize a specific device within the iOS ecosystem. Additionally, Apple devices possess an Advertising Identifier (IDFA), an anonymous identifier generated for advertising purposes. Similarly, Google devices have a Google Advertising ID (GAID), serving the same purpose as the IDFA but for devices operating within the Android ecosystem. Another identifier associated with the second user device is its phone number, assigned to the device's SIM card for voice calls and text messaging. Furthermore, the second user device may possess a Serial Number, a unique identifier provided by the manufacturer for device identification and warranty purposes. It also has a Build Number, serving as an identifier associated with the software build installed on the device. The Subscriber Identity Module (SIM) Serial Number is another identifier, unique to the SIM card inserted into the second user device. Finally, while not a static identifier, location data generated by the second user device can also serve as an identifying factor in certain contexts, providing insights into the device's whereabouts and usage patterns. These identifiers collectively serve various functions, including device authentication, tracking, analytics, and targeted advertising.

At 920, one or more resource identifiers may be inserted into the communication request. For example, the one or more resource identifiers may comprise one or more URLs, one or more URIs, and/or one or more URNs. The one or more resource identifiers may be configured to cause an action at the receiving device. For example, the one or more resource identifiers may be configured to cause the receiving device to send one or more requests. For example, the one or more actions may comprise one or more HTTP GETs, one or more email fetches, one or more browser actions, one or more security actions, outputting one or more alerts, combinations thereof, and the like.

At 930, the communication request may be sent. For example, the communication request may be sent by the network device (e.g., a switch) towards a receiving device. The communication request may cross an originating network, a transit network, and/or a terminating network before being received by the recipient device.

At 940, one or more resource requests may be received. The one or more resource requests may be received from second user device (e.g., the device that received the communication request). The one or more resource requests may comprise one or more HTTP GETs.

At 950, the second device may be caused to output audio. The audio may comprise one or more pre-call announcements. For example, the audio may be the result of a text to speech conversion. For example, where the outgoing call comprises RCD, text may be determined based on the RCD, the text may be converted to audio (e.g., via a text-to-speech) conversion, and the audio may be output.

At 960, a communication session may be established. The communication session may comprise a POTS call, SIP call/SIP session, H.323 session, WebRTC session, Jingle session, SIP over WebSocket, or IP multimedia session.

The method may comprise receiving, via the first user device, voice input data, wherein the audio data comprises the voice input data. The method may comprise receiving, from the second user device, based on the audio data, a user input. The method may comprise opening, based on the user input, a communication session between the first user device and the second user device. The method may comprise terminating a communication session.

The method may comprise receiving, from a first user device, a communication comprising supplemental data and an identifier associated with a second user device. The method may comprise determining, based on the identifier associated with the second user device, that the second user device is not configured to process the supplemental data. The method may comprise causing the second user device to output an audio representation of the supplemental data.

The method may comprise receiving, by a network device, from a first user device, a communication request comprising an identifier associated with a second user device. The method may comprise inserting, by the network device, into the communication request, a resource identifier. The method may comprise sending, based on the identifier associated with the second user device, the communication request. The method may comprise determining, based on the resource identifier, that the second user device did not send a resource request. The method may comprise based on determining the second user device did not send the resource request, inserting, into the communication request, audio data. The method may comprise causing, based on the audio data, the second user device to output audio.

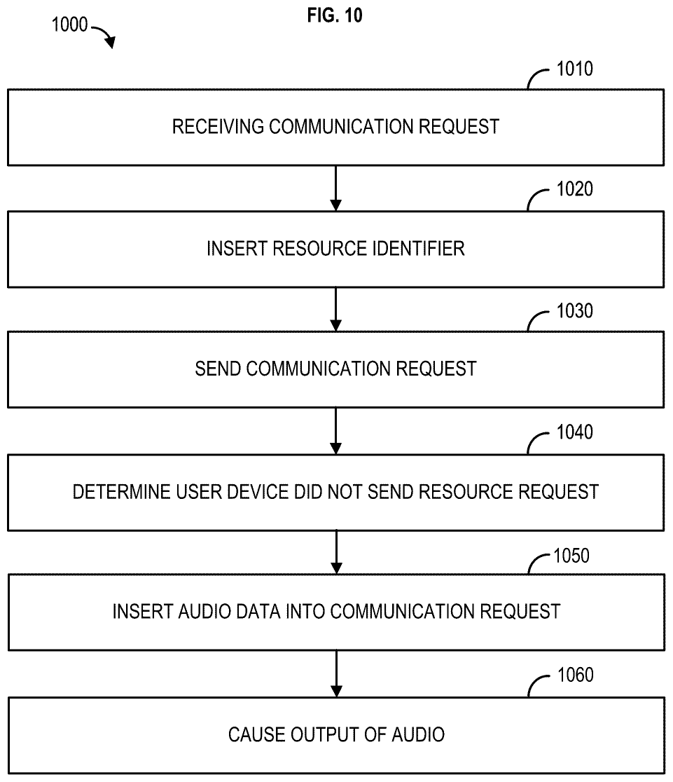

FIG. 10 shows an example method 1000. The method 1000 may be carried out via any one or more of the devices described herein. At 1010, a communication request may be received. The communication request may be received by a network device. The communication request may be sent by a user device. The user device sending the communication request may be referred to as the originating device. The originating device may comprise, for example, a phone (e.g., cell phone, landline phone, smartphone), a computer (e.g., a laptop, tablet, desktop), or other smart device (e.g., smart glasses or smart watch).

The network device may comprise a switch device. The communication request may comprise one or more identifiers associated with an originating device. The communication request may comprise one or more identifiers associated with a recipient device. The communication request may comprise supplemental data (RCD).

At 1020, a resource identifier may be inserted into the communication request. The one or more resource identifiers may be associated with one or more resources. For example, the one or more resource identifiers may comprise one or more uniform resource locators (URLs), one or more uniform resource identifiers (URIs), one or more uniform resource names (URNs), combinations thereof, and the like. For example, a URL may be configured to specify the location of one or more resources via the Internet and a protocol used to access the one or more resources. A URN may be configured to uniquely identify one or more resources without specifying a location or how to access the one or more resources.

At 1030, the communication request may be sent. The communication request may be sent to the recipient device. The communication request may be sent by the originating device to one or more networks (e.g., an originating network, a transit network, and/or a terminating network). Sending the communication request may comprising initiating a SIP protocol handshake.

At 1040, it may be determined that the second user device (e.g., the recipient device) did not send a resource request. For example, it may be determined that a resource request was not received from the recipient device within a threshold period of time. For example, it may be determined the resource in the communication request was not accessed by the recipient device. Based on determining the second user device is not configured to send a resource request, it may be determined that the recipient device is not configured to process RCD. RCD.

At 1050, audio data may be inserted into the communication request. The audio data may comprise one or more pre-call announcements. The audio data may comprise one or more IVR prompts. The audio data may be received via the originating device. For example, a user at the originating device may be prompted to provide one or more responses to one or more prompts. For example, a pre-call announcement may occur during the process of setting up the call session (e.g., via early media (183 session process response for the communication request) or after 200 OK, by establishing the media session as an B2BUA (back to back user agent) to play the announcement before establishing the full communication session between both the parties).

At 1060, audio may be output by the recipient device. For example, the audio may comprise the one or more pre-call announcements. For example, the audio may be the result of a text to speech conversion. For example, where the outgoing call comprises RCD, text may be determined based on the RCD, the text may be converted to audio (e.g., via a text-to-speech) conversion, and the audio may be output.

The method may comprise receiving, via the first user device, voice input data, wherein the audio data comprises the voice input data. The method may comprise receiving, from the second user device, based on the audio data, a user input. The method may comprise opening, based on the user input, a communication session between the first user device and the second user device. The method may comprise terminating a communication session. The method may comprise forwarding the communication request to a STIR/SHAKEN server. The method may comprise forwarding the communication request to a pre-call announcement server.

The method may comprise receiving, from a first user device, a communication comprising supplemental data and an identifier associated with a second user device. The method may comprise determining, based on the identifier associated with the second user device, that the second user device is not configured to process the supplemental data. The method may comprise causing the second user device to output an audio representation of the supplemental data.

The method may comprise receiving, by a network device, from a first user device, a communication request comprising an identifier associated with a second user device. The method may comprise inserting, by the network device, into the communication request, a resource identifier. The method may comprise sending, based on the identifier associated with the second user device, the communication request. The method may comprise receiving, from the second user device, based on the resource identifier, a resource request. The method may comprise causing, based on the resource request, the second user device to output audio. The method may comprise receiving, from the second user device, based on the audio, a user input. The method may comprise opening, based on the user input, a communication session between the first user device and the second user device.

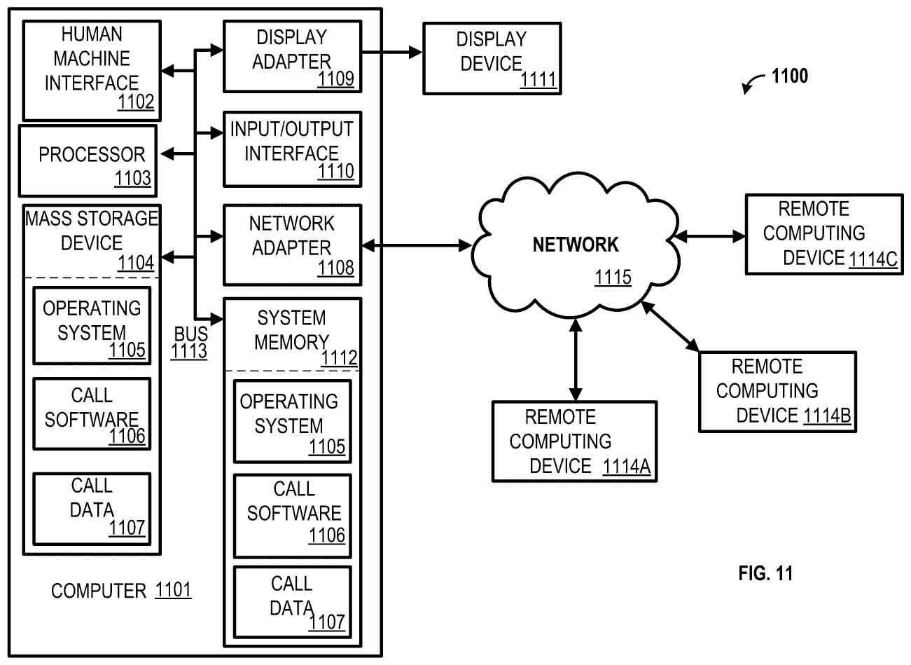

FIG. 11 shows a system 1100 for communication management. The media device 120, the output device 121, the communication terminal 122, the mobile device 124, the content source 102, the encoder 104, the one or more wagering services 108, and/or the network component 129 of FIG. 1 may be a computer 1101 as shown in FIG. 11. The computer 1101 may comprise one or more processors 1103, a system memory 1112, and a bus 1113 that couples various system components including the one or more processors 1103 to the system memory 1112. In the case of multiple processors 1103, the computer 1101 may utilize parallel computing. The bus 1113 is one or more of several possible types of bus structures, including a memory bus or memory controller, a peripheral bus, an accelerated graphics port, or local bus using any of a variety of bus architectures.

The computer 1101 may operate on and/or comprise a variety of computer readable media (e.g., non-transitory). The readable media may be any available media that is accessible by the computer 1101 and may comprise both volatile and non-volatile media, removable and non-removable media. The system memory 1112 has computer readable media in the form of volatile memory, such as random access memory (RAM), and/or non-volatile memory, such as read only memory (ROM). The system memory 1112 may store data such as the call data 1107 and/or program modules such as the operating system 1105 and the call software 1106 that are accessible to and/or are operated on by the one or more processors 1103. The machine learning module may comprise one or more of the call data 1107 and/or the call software 1106.

The computer 1101 may also comprise other removable/non-removable, volatile/non-volatile computer storage media. FIG. 11 shows the mass storage device 1104 which may facilitate non-volatile storage of computer code, computer readable instructions, data structures, program modules, and other data for the computer 1101. The mass storage device 1104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1104, such as the operating system 1105 and the call software 1106. Each of the operating system 1105 and the call software 1106 (or some combination thereof) may comprise elements of the program modules and the call software 1106. The call data 1107 may also be stored on the mass storage device 1104. The call data 1107 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1115.

A user may enter commands and information into the computer 1101 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1103 via a human machine interface 1102 that is coupled to the bus 1113, but may be connected by other interface and bus structures, such as a parallel port, game port, an IEEE 1394 Port (also known as a Firewire port), a serial port, network adapter 1108, and/or a universal serial bus (USB).

The display device 1111 may also be connected to the bus 1113 via an interface, such as the display adapter 1109. It is contemplated that the computer 1101 may comprise more than one display adapter 1109 and the computer 1101 may comprise more than one display device 1111. The display device 1111 may be a monitor, an LCD (Liquid Crystal Display), light emitting diode (LED) display, television, smart lens, smart glass, and/or a projector. In addition to the display device 1111, other output peripheral devices may be components such as speakers (not shown) and a printer (not shown) which may be connected to the computer 1101 via the Input/Output Interface 1110. Any step and/or result of the methods may be output (or caused to be output) in any form to an output device. Such output may be any form of visual representation, including, but not limited to, textual, graphical, animation, audio, tactile, and the like. The display device 1111 and computer 1101 may be part of one device, or separate devices.

The computer 1101 may operate in a networked environment using logical connections to one or more remote computing devices 1114A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1101 and a remote computing device 1114A,B,C may be made via a network 1115, such as a local area network (LAN) and/or a general wide area network (WAN). Such network connections may be through the network adapter 1108. The network adapter 1108 may be implemented in both wired and wireless environments. Such networking environments are conventional and commonplace in dwellings, offices, enterprise-wide computer networks, intranets, and the Internet.

Application programs and other executable program components such as the operating system 1105 are shown herein as discrete blocks, although it is recognized that such programs and components reside at various times in different storage components of the computing device 1101, and are executed by the one or more processors 1103 of the computer. An implementation of the call software 1106 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the quantity or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, from a first user device, a communication comprising supplemental data and one or more identifiers associated with a second user device;
determining, based on the one or more identifiers associated with the second user device, that the second user device is not configured to process the supplemental data; and
causing the second user device to output an audio representation of the supplemental data.

2. The method of claim 1, wherein the communication comprises a communication request, and wherein the supplemental data comprises rich call data.

3. The method of claim 1, wherein causing the second user device to output the audio representation of the supplemental data comprises causing the second user device to play a pre-call announcement, and wherein determining the second user device is not configured to process the supplemental data is based on the one or more identifiers associated with the second user device.

4. The method of claim 1, wherein the supplemental data comprises image data configured to be output by a display, the method further comprising:
converting the supplemental data to text data; and
converting the text data to audio data.

5. The method of claim 1, further comprising:
receiving, from the second user device, a user input; and
opening, based on the user input, a communication session between the first user device and the second user device.

6. The method of claim 1, further comprising:
determining, based on a user input associated with the second user device, a communication session open command; and
opening, based on the communication session open command, a communication session between the first user device and the second user device.

7. The method of claim 1, further comprising:
sending, to a call log server, text data; and
sending, to the second user device, a pre-recorded voicemail message.

8. A method comprising:
receiving, by a network device, from a first user device, a communication request comprising one or more identifiers associated with a second user device;
inserting, by the network device, into the communication request, one or more resource identifiers;
sending, based on the one or more identifiers associated with the second user device, the communication request;
receiving, from the second user device, based on the one or more resource identifiers, one or more resource requests;
causing, based on the one or more resource requests, the second user device to output audio;
receiving, from the second user device, based on the audio, a user input; and
establishing, based on the user input, a communication session between the first user device and the second user device.

9. The method of claim 8, wherein the network device comprises a switch device, and wherein the audio comprises a pre-recorded message.

10. The method of claim 8, causing the second user device to output the audio comprises causing the second user device to output a pre-call announcement and an option configured to solicit the user input.

11. The method of claim 10, wherein inserting the one or more resource identifiers comprises inserting a URL into a data packet associated with the call.

12. The method of claim 10, further comprising determining that the second user device accessed one or more resources associated with the one or more resource identifiers.

13. The method of claim 8, further comprising receiving, via the first user device, voice input data, wherein the audio comprises the voice input data.

14. The method of claim 8, further comprising causing, based on the one or more resource identifiers, the second user device to modify a notification parameter.

15. A method comprising:
receiving, by a network device, from a first user device, a communication request comprising one or more identifiers associated with a second user device;
inserting, by the network device, into the communication request, a resource identifier;
sending, based on the one or more identifiers associated with the second user device, the communication request;
determining, based on the resource identifier, that the second user device did not send a resource request;
based on determining the second user device did not send the resource request, inserting, into the communication request, audio data; and
causing, based on the audio data, the second user device to output audio.

16. The method of claim 15, wherein the network device comprises a switch device, and wherein the audio data comprises a pre-call announcement and an option configured to solicit a user input.

17. The method of claim 15, wherein the resource identifier comprises a URL.

18. The method of claim 15, further comprising receiving, via the first user device, voice input data, wherein the audio data comprises the voice input data.

19. The method of claim 15, further comprising:
receiving, from the second user device, based on the audio data, a user input; and
opening, based on the user input, a communication session between the first user device and the second user device.

20. The method of claim 15, further comprising terminating a communication session.
